(19) United States
(12) Patent Application Publication
(10) Pub. No.: US 2009/0027359 A1
(43) Pub. Date: Jan. 29, 2009

(54) STYLUS WITH SUCTION CUP

(75) Inventors: Shih-Fang Wong, Tu-Cheng (TW); Jun-Wei Zhang, Shenzhen City (CN); Li-Ping Li, Shenzhen City (CN); Tao Zeng, Shenzhen City (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/168,843

(22) Filed: Jul. 7, 2008

(30) Foreign Application Priority Data
Jul. 23, 2007 (CN) 200710201156.6

(51) Int. Cl. G06F 3/033

(52) U.S. Cl. 345/179

(57) ABSTRACT

A stylus includes a suction cup configured for being attached to a user' finger and a touch body mounted on the suction cup. In using this kind of stylus, a user can accomplish an input operation in a portable electronic device by using one hand to hold the portable electronic device and using a finger of the same hand to manipulate the stylus.

### BACKGROUND

1. Technical Field

The present invention relates to a stylus.

2. General Background

Touch screens are widely used as input elements for electronic devices. A stylus is usually used as an aide for inputting information via the touch screen. Most styluses are thin, pen-like instruments. When using the stylus, one hand is needed to hold the portable electronic device, and the other hand is needed to manipulate the stylus. Thus, both hands are occupied. This is an inconvenience for a user that may need to multi-task using both hands.

Therefore, what is needed is a stylus which allows a user to input information to a portable electronic device using one hand for manipulating both the stylus and the portable electronic device.

### SUMMARY

A stylus is disclosed. The stylus includes a suction cup configured for being attached to a user's finger and a touch body mounted on the suction cup.

Further features and advantages will be provided or will become apparent in the course of the following detailed description.

### BRIEF DESCRIPTION OF THE DRAWINGS

The components of the drawings are not necessarily drawn to scale, the emphasis instead being placed upon clearly illustrating the principles of the input device and the electronic device. Moreover, in the drawings, like reference numerals designate corresponding parts throughout the several views.

FIG. 1 is a isometric view of a stylus according to a first exemplary embodiment of the present invention.

FIG. 2 is an exploded view of FIG. 1.

FIG. 3 is an exploded view of a stylus according to a second exemplary embodiment of the present invention.

### DETAILED DESCRIPTION OF THE EMBODIMENT

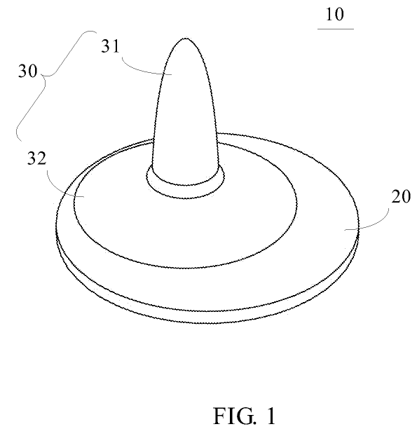

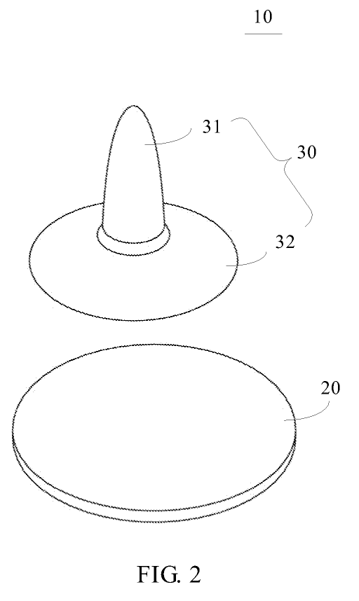

Referring to FIGS. 1 and 2, a stylus 10 according to a first exemplary embodiment of the present invention is disclosed. The stylus 10 includes a touch body 30 and a suction cup 20.

The suction cup 20 is made of rubber or plastic. The suction cup 20 is configured for adhering to human's skin, for example, a fleshly part of a user's thumb.

The touch body 30 is a bullet shaped, and includes a base 32 and a tip 31. The base 32 is made up of metal or plastic, and is attached (via glue or fastening means) to the suction cup 20. The tip 31 is made up of metal or plastic. Because plastic is less likely, than metal, to scratch a touch screen, the tip 31 is preferably made of plastic. The tip 31 connects with the base 32.

The user can hold a portable electronic device with a touch screen with the user's palm, and adhere the stylus 10 to the thumb of the same palm via the suction cup 20, in a such manner the user can perform input operations using only one hand.

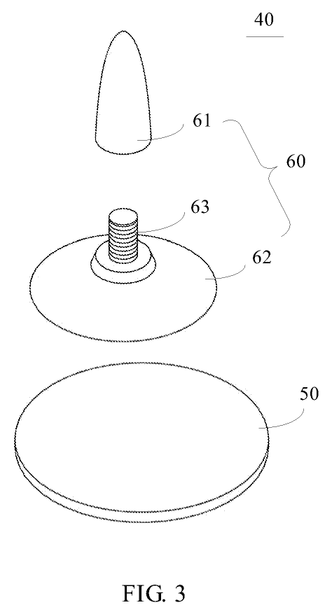

Referring to FIG. 3, a stylus 40 according to a second exemplary embodiment of the present invention is disclosed. The stylus 40 includes a suction cup 50 and a touch body 60. The touch body 60 includes a base 62 and a tip 61. The base 62 includes a screw rod 63 on an up end thereof. A screw hole defined in the tip 61 (not shown) cooperates with the screw rod 63 to connect the tip 61 and the base 62. Except for the screw connection structure of the base 62 and the tip 61, the stylus 40 is similar to the stylus 10.

It is to be understood that the invention may be embodied in other forms without departing from the spirit thereof. Thus, the present examples and embodiments are to be considered in all respects as illustrative and not restrictive, and the invention is not to be limited to the details given herein.

What is claimed is:

1. A stylus comprising:
a suction cup configured for being attached to a user's finger; and
a touch body mounted on the suction cup.

2. The stylus of claim 1, wherein the touch body is bullet shaped.

3. The stylus of claim 1, wherein the touch body is glued to the suction cup.

4. The stylus of claim 1, wherein the touch body comprises a base connected to the suction cup and a tip connected to the base.

5. The stylus of claim 4, wherein the tip and the base respectively comprise a screw hole and a screw rod cooperating to each other.
